(19) United States
(12) Patent Application Publication
(10) Pub. No.: US 2023/0348786 A1
(43) Pub. Date: Nov. 2, 2023

(54) FLAME RETARDANT PHOSPHONIUM DICARBOXYLIC ACID IONIC LIQUID COMPOUND, FLAME RETARDANT SYNTHETIC POLYMER, FIBER AND FABRIC CONTAINING THE SAME

(71) Applicant: MATERIALS MODIFICATION INC., FAIRFAX, VA (US)

(72) Inventors: KRISHNASWAMY KASTHURI RANGAN, FAIRFAX, VA (US); TIRUMALAI SRINIVAS SUDARSHAN, VIENNA, VA (US)

(73) Assignee: MATERIALS MODIFICATION INC., FAIRFAX, VA (US)

(21) Appl. No.: 18/121,068

(22) Filed: Mar. 14, 2023

Related U.S. Application Data
(60) Provisional application No. 63/321,567, filed on Mar. 18, 2022.

(51) Int. Cl. C09D 5/18; C07F 9/54; C09K 21/14; C08G 69/42; C09D 177/06

(52) U.S. Cl. CPC C09K 21/14; C07F 9/5407; C08G 69/42; C09D 5/18; C09D 177/06

(57) ABSTRACT

A phosphorus-containing ionic liquid, a phosphorus-containing a flame retardant additive, and a preparation method thereof are provided. Also provided are co-monomer salt compositions for flame retardant polymers. Also provided are polymers that comprise the phosphorus-containing flame retardant ionic liquid or flame retardant co-monomer salt. The resin composition may be used to make various articles, including fibers, fabrics, and yarns.

This application claims the benefit of U.S. Provisional Application No. 63/321,567 filed Mar. 18, 2022.

### STATEMENT REGARDING FEDERALLY SPONSORED RESEARCH OR DEVELOPMENT.

This invention was made with the support of the Government of the United States of America under SBIR contract number 80NSSC21C0285 (2021), awarded by NASA. The Government of the United States of America has certain rights in the invention.

### FIELD

This disclosure relates to a phosphonium salt-containing dicarboxylic acid group. This disclosure relates to a flame retardant phosphonium salt-containing dicarboxylate group. This disclosure provides a phosphonium salt-containing dicarboxylic acid group as a flame retardant (referred to as ‘FR’ in this disclosure) additive to polymers.

### BACKGROUND

In this section, we discuss several aspects of related work, including background and conventional technologies.

### Flame Retardant Textiles and Flame Retardant Polymers

Since the beginning of Apollo missions in the ‘60s, NASA has taken the safety of astronauts as the primary priority in all crewed space missions. Beta fiberglass, polybenzimidazole (PBI), polybenzoxazole (PBO), halogenated polyamides and polyimides, chlorotrifluoroethylene, and a combination of several of these fibers were used for flame retardant fabrics.

Polyamide 6,6 (referred as “PA6,6” in this disclosure) fibers are the most suitable materials to design clothing for space, military, firefighters, and industrial applications. These fibers are soft and comfortable and keep the wearer dry, and it has high strength and durability after repeated washing. Most current commercial textiles use Polyamide fibers. However, Polyamide fibers are not flame retardant and require flame retardant treatment. Most of the commercially available flame retardant solutions contain halogenated materials. Furthermore, most flame retardant textile solutions are surface coatings that lack durability (withstanding laundering of 25 or more cycles).

It is a relatively easy process to develop flame retardant cotton, as the reactive hydroxyl groups on the surface allow bonding for most reactive flame retardant materials. The polyamide polymers lack such reactive groups. There have been many attempts to design and develop durable flame retardant textile finishes for polyamide, but none have surpassed the stringent demands required by the military, space, or commercial standards. For example, Polyamide 6 textile was first hydroxymethylated, and then the methylol group-containing Polyamide 6 textiles were finished with Pyrovatex CP at 160-170° C. The limiting oxygen index (LOI) value increased from 23.6 for the original textile to 31.4 for the modified textile.

Another approach was to add flame-retardant chemicals prior to the extrusion in the spinning dope or to the spinning bath. However, most of the commonly used phosphorus, metal, and halogen additives are not stable at the Polyamide fiber spinning temperature (>250° C.). The addition of external additives also degrades the properties of polyamide. Another drawback is the leaching of low molecular weight flame retardant compounds over a long period of time. Leaching of the additives affects not only the surface appearance but also the inherent flame retardancy. On the other hand, high molecular weight flame retardant additives are not readily lost from the polymer but exhibit compatibility and miscibility problems with Polyamide resins.

Organic phosphorus compounds are among the most frequently used flame retardants and represent a halogen-free alternative. Phosphonic acid derivatives were incorporated into the polymer chain for flame retardancy. Vasiljevic et al. explored the effect of flame-retardant bridged 9,10-dihydro-9-oxa-10-phosphaphenanthrene-10-oxide (DOPO) derivatives on PA6/flame retardant systems (Vasiljević, J., Čolović, M., Jerman, I., Símončič, B., Demšar, A., Samaki, Y., Šobak, M., Šest, E., Golja, B., Leskovšek, M., In situ prepared polyamide 6/DOPO-derivative nanocomposite for melt-spinning of flame retardant textile filaments. Polymer Degradation and Stability 2019, 166, 50-59; Vasiljević, J., Čolović, M., Čelan Korošin, N., Šobak, M., Štirn, Ž., Jerman, I., Effect of different flame-retardant bridged Dopo derivatives on properties of in situ produced fiber-forming polyamide 6. Polymers 2020, 12 (3), 657.)

There are several research efforts reported on imparting flame retardancy to Polyamide 6.6 (PA6,6) (obtained from adipic acid/1,6 hexamethylenediamine precursors) and for Polyamide 6 (PA6) fibers (derived from polycaprolactam). Few literature references are as follows: Ge, H., Wang, W., Pan, Y., Yu, X., Hu, W., Hu, Y., An inherently flame-retardant polyamide containing a phosphorus pendent group prepared by interfacial polymerization. RSC advances 2016, 6 (85), 81802-81808; Lyu, W., Cui, Y., Zhang, X., Yuan, J., Zhang, W., Synthesis, thermal stability, and flame retardancy of PA66, treated with dichlorophenylphosphine derivatives. Designed Monomers and Polymers 2016, 19 (5), 420-428; Li, Y.; Liu, K., Xiao, R. In Preparation and characterizations of flame-retardant polyamide 66 fiber, IOP Conference Series: Materials Science and Engineering, IOP Publishing: 2017; p 012040; Liu, K.; Li, Y., Tao, L., Xiao, R., Preparation and characterization of polyamide 6 fiber based on a phosphorus-containing flame retardant. RSC advances 2018, 8 (17), 9261-9271; Xiang, H.; Li, L., Chen, W., Yu, S., Sun, B., Zhu, M., Flame retardancy of polyamide 6 hybrid fibers: Combined effects of α-zirconium phosphate and ammonium sulfamate. Progress in Natural Science: Materials International 2017, 27 (3), 369-373; Mourgas, G., Giebel, E., Bauch, V., Schneck, T., Unold, J., Buchmeiser, M. R., Synthesis of intrinsically flame-retardant copolyamides and their employment in PA6-fibers. Polymers for Advanced Technologies 2019, 30 (11), 2872-2882.

Currently known surface treatment or coating technologies or mixing with flame retardant additives during the melt spinning process will not yield durable intrinsically flame-retardant polyimide that can function effectively at a 36% oxygen environment.

In view of these limitations, improved flame retardant compounds and fabrics prepared from them are required.

### BRIEF DESCRIPTION OF DRAWINGS

FIG. 1 provides chemical structure of flame retardant ionic liquid compound of Formula 1, wherein (R₁, R₂, R₃ is an alkyl group having CₙH₂ₙ₊₁ (n = 1 to 20) or aryl groups; X is dicarboxylic acid containing group and A⁻ is an anion.

FIG. 2A provides Attenuated total reflectance spectra of T-H salt (also Formula 3) from Example 3.

FIG. 2B provides Attenuated total reflectance (ATR) spectra of TAH salt (also referred to as Formula 4) from Example 3.

FIG. 3A provides proton nuclear magnetic resonance (NMR) spectra of tributyl succinyl phosphonium bromide prepared in Example 1.

FIG. 3B provides ³¹P NMR spectrum of tributyl succinyl phosphonium bromide prepared in Example 1.

FIG. 4A provides ³¹P NMR spectra of T-H salt, also referred as Formula 3, from Example 3.

FIG. 4B provides P³¹ NMR spectra of TAH salt (bromide anion in TA salt ion-exchanged with adipate anion), also referred as Formula 4 from Example 3.

FIG. 5A provides Attenuated total reflectance spectrum of polymer Polyamide 6,6 Reference sample.

FIG. 5B provides Attenuated total reflectance spectrum of flame retardant polyamide 6,6 (FR-PA) prepared using T-H salt.

FIG. 5C provides Attenuated total reflectance spectrum of halogen free flame retardant polyamide 6,6 (HF-FR-PA) prepared from the intermediate TAH salt.

FIG. 6A provides P-31 Solid-State NMR spectra of polyamide polymer prepared by incorporating T-H salt from Example 3.

FIG. 6B provides P-31 Solid-State NMR spectra of polyamide polymer prepared by incorporating TAH salt (bromide anion in TA salt ion-exchanged with adipate anion) from Example 3.

FIG. 7A provides powder x-ray diffraction (XRD) pattern of Polyamide 6,6 reference sample.

FIG. 7B provides powder XRD pattern of flame retardant polyamide 6,6 (FR-PA) prepared using T-H salt.

FIG. 7C powder XRD pattern of halogen free flame retardant polyamide 6,6 (HF-FR-PA) prepared using TAH salt.

FIG. 8 Aprovides thermogravimetric analysis (TGA) plot of polyamide 6,6.

FIG. 8B provides TGA plot of halogen free flame retardant polyamide 6,6 (HF-FA-PA) prepared using TAH salt.

FIG. 9A provides scanning electron microscopy (SEM) images of Polyamide 6 (PA6).

FIG. 9B provides SEM images of flame retardant polyamide 6,6 FR-PA/PA6 yarns.

### SUMMARY

The disclosed teachings provide a flame retardant ionic liquid compound represented by the structure of Formula 1:

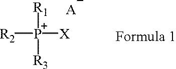

[36] wherein
X is a chemical moiety having a dicarboxylic acid group selected from the group consisting of oxalic acid (ethanedioic acid), malonic acid (propanedioic acid), succinic acid (butanedioic acid), glutaric acid (pentanedioic acid), adipic acid (hexanedioic acid), pimelic acid (heptanedioic acid), suberic acid (octanedioic acid), azelaic acid (nonanedioic acid), sebacic acid (decanedioic acid), undecanedioic acid, dodecanedioic acid, brassylic acid (tridecanedioic acid), thapsic acid (hexadecanedioic acid), heneicosanedioic acid, docosanedioic acid, triacontanedioic acid, and combinations thereof;
R₁ is selected from the group consisting of an alkyl group, an aryl group and combinations thereof;
R₂ is selected from the group consisting of an alkyl group, an aryl group and combinations thereof;
R₃ is selected from the group consisting an alkyl group, an aryl group and combinations thereof;
A⁻ is an anion selected from the group consisting of bromide, chloride, iodide, adipate, and succinate, oxalate, malonate, glutarate, pimelicate, subericate (octanedioic carboxylic anion), and combinations thereof;
wherein the alkyl group is CₙH₂ₙ₊₁; and wherein n = 1 to 20.

Disclosed teachings provide a flame retardant intermediate compound represented by structure of Formula 2:

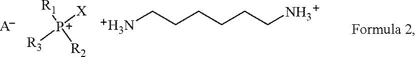

wherein
X is a chemical moiety having a dicarboxylic acid group selected from the group consisting of oxalic acid (ethanedioic acid), malonic acid (propanedioic acid), succinic acid (butanedioic acid), glutaric acid (pentanedioic acid), adipic acid (hexanedioic acid), pimelic acid (heptanedioic acid), suberic acid (octanedioic acid), azelaic acid (nonanedioic acid), sebacic acid (decanedioic acid), undecanedioic acid, dodecanedioic acid, brassylic acid (tridecanedioic acid), thapsic acid (hexadecanedioic acid), heneicosanedioic acid, docosanedioic acid, triacontanedioic acid, and combinations thereof;
R₁ is selected from the group consisting of an alkyl group, an aryl group and combinations thereof;
R₂ is selected from the group consisting of an alkyl group, an aryl group and combinations thereof;
R₃ is selected from the group consisting an alkyl group, an aryl group and combinations thereof;
A⁻ is an anion selected from the group consisting of bromide, chloride, iodide, adipate, and succinate, oxalate, malonate, glutarate, pimelicate, subericate (octanedioic carboxylic anion), and combinations thereof;
wherein the alkyl group is CₙH₂ₙ₊₁; and wherein n = 1 to 20.

Disclosed teachings provide a flame retardant polymer having a polymerization product of the flame retardant ionic liquid compound of Formula 1.

A flame retardant polymer having the polymerization product of the flame retardant ionic liquid compound of Formula I is selected from the group consisting of a polyamide, a polyester, a polyurethane, a polyimide or combinations thereof.

Disclosed teachings provide flame retardant polyamide having a polymerization product of the flame retardant intermediate compound of Formula 2

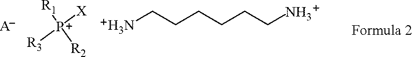

wherein X is a chemical moiety having a dicarboxylic acid group selected from the group consisting of oxalic acid (ethanedioic acid), malonic acid (propanedioic acid), succinic acid (butanedioic acid), glutaric acid (pentanedioic acid), adipic acid (hexanedioic acid), pimelic acid (heptanedioic acid), suberic acid (octanedioic acid), azelaic acid (nonanedioic acid), sebacic acid (decanedioic acid), undecanedioic acid, dodecanedioic acid, brassylic acid (tridecanedioic acid), thapsic acid (hexadecanedioic acid), heneicosanedioic acid, docosanedioic acid, triacontanedioic acid, and combinations thereof;
R₁ is selected from the group consisting of an alkyl group, an aryl group and combinations thereof;
R₂ is selected from the group consisting of an alkyl group, an aryl group and combinations thereof;
R₃ is selected from the group consisting an alkyl group, an aryl group and combinations thereof;
A⁻ is an anion selected from the group consisting of bromide, chloride, iodide, adipate, and succinate, oxalate, malonate, glutarate, pimelicate, subericate (octanedioic carboxylic anion), and combinations thereof;
wherein the alkyl group is CₙH₂ₙ₊₁; and wherein n = 1 to 20.

Disclosed teachings provide a flame retardant intermediate compound represented by the structure of Formula 3:

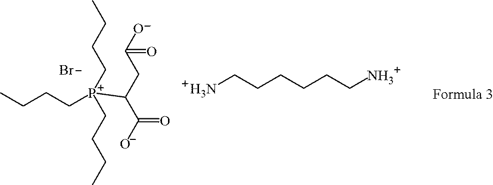 [SMILES: CCCC[P+](CCCC)(CCCC)C(CC(=O)[O-])C(=O)[O-] ; [Br-] ; [NH3+]CCCCCC[NH3+]]

Disclosed teachings provide a flame retardant intermediate compound represented by the structure of Formula 4

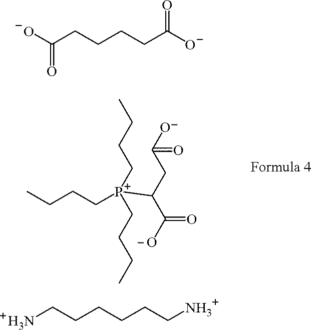 [SMILES: O=C([O-])CCCCC(=O)[O-] ; CCCC[P+](CCCC)(CCCC)C(CC(=O)[O-])C(=O)[O-] ; [NH3+]CCCCCC[NH3+]]

### DETAILED DESCRIPTION

This disclosure provides precursors, additives, or co-monomers for intrinsically flame-retardant polyamide fibers using phosphonium precursor salts containing dicarboxylate groups. Tributyl phosphonium groups could be incorporated in the flame-retardant polymeric backbone, which could be melt-extruded into textile fibers. The dicarboxylate groups can directly bond-forming the intrinsic part of the polymeric chain.

The phosphonium salts containing dicarboxylic groups can be used as a precursor to impart flame retardancy to polymers.

The phosphonium salts containing dicarboxylic groups can be used as a flame retardant additive to polymers.

The phosphonium salts containing dicarboxylic groups can be used as co-monomers to polymers such as polyamide, polyimide, polyurethane and polyester.

Without wishing to be bound by any theory, incorporation of phosphonium group (P—R₄) instead of phosphonic, phosphorous bonded to 3 oxygen and carbon, R—P(OR)₃ or phosphitic (P(OR)₃ or phosphate (PO₄ or P(OR)₄) groups, where R is H or CₙH_{2n+!} Alkyl groups (n = 1 to 20) or aryl groups, or a mixture of both alkyl and aryl groups, are expected to increase the thermal stability of the flame retardant polymer. This disclosure deals with the flame retardant composition containing P-R₄ groups, that is, phosphorus bonded to four carbon atoms directly.

The disclosed teachings provide a flame retardant ionic liquid compound represented by the structure of Formula 1:

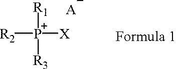

wherein
X is a chemical moiety having a dicarboxylic acid group selected from the group consisting of oxalic acid (ethanedioic acid), malonic acid (propanedioic acid), succinic acid (butanedioic acid), glutaric acid (pentanedioic acid), adipic acid (hexanedioic acid), pimelic acid (heptanedioic acid), suberic acid (octanedioic acid), azelaic acid (nonanedioic acid), sebacic acid (decanedioic acid), undecanedioic acid, dodecanedioic acid, brassylic acid (tridecanedioic acid), thapsic acid (hexadecanedioic acid), heneicosanedioic acid, docosanedioic acid, triacontanedioic acid, and combinations thereof;
R₁ is selected from the group consisting of an alkyl group, an aryl group and combinations thereof;
R₂ is selected from the group consisting of an alkyl group, an aryl group and combinations thereof;
R₃ is selected from the group consisting an alkyl group, an aryl group and combinations thereof;
A⁻ is an anion selected from the group consisting of bromide, chloride, iodide, adipate, and succinate, oxalate, malonate, glutarate, pimelicate, subericate (octanedioic carboxylic anion), and combinations thereof;
wherein the alkyl group is CₙH₂ₙ₊₁; and wherein n = 1 to 20.

Disclosed teachings provide a flame retardant intermediate compound represented by structure of Formula 2:

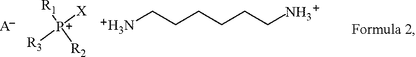

wherein
X is a chemical moiety having a dicarboxylic acid group selected from the group consisting of oxalic acid (ethanedioic acid), malonic acid (propanedioic acid), succinic acid (butanedioic acid), glutaric acid (pentanedioic acid), adipic acid (hexanedioic acid), pimelic acid (heptanedioic acid), suberic acid (octanedioic acid), azelaic acid (nonanedioic acid), sebacic acid (decanedioic acid), undecanedioic acid, dodecanedioic acid, brassylic acid (tridecanedioic acid), thapsic acid (hexadecanedioic acid), heneicosanedioic acid, docosanedioic acid, triacontanedioic acid, and combinations thereof;
R₁ is selected from the group consisting of an alkyl group, an aryl group and combinations thereof;
R₂ is selected from the group consisting of an alkyl group, an aryl group and combinations thereof;
R₃ is selected from the group consisting an alkyl group, an aryl group and combinations thereof;
A is an anion selected from the group consisting of bromide, chloride, iodide, adipate, and succinate, oxalate, malonate, glutarate, pimelicate, subericate (octanedioic carboxylic anion), and combinations thereof;
wherein the alkyl group is CₙH₂ₙ₊₁; and wherein n = 1 to 20.

Disclosed teachings provide a flame retardant polymer having a polymerization product of the flame retardant ionic liquid compound of Formula 1.

A flame retardant polymer having the polymerization product of the flame retardant ionic liquid compound of Formula I is selected from the group consisting of a polyamide, a polyester, a polyurethane, a polyimide or combinations thereof.

Disclosed teachings provide flame retardant polyamide having a polymerization product of the flame retardant intermediate compound of Formula 2

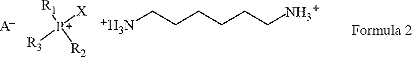

wherein X is a chemical moiety having a dicarboxylic acid group selected from the group consisting of oxalic acid (ethanedioic acid), malonic acid (propanedioic acid), succinic acid (butanedioic acid), glutaric acid (pentanedioic acid), adipic acid (hexanedioic acid), pimelic acid (heptanedioic acid), suberic acid (octanedioic acid), azelaic acid (nonanedioic acid), sebacic acid (decanedioic acid), undecanedioic acid, dodecanedioic acid, brassylic acid (tridecanedioic acid), thapsic acid (hexadecanedioic acid), heneicosanedioic acid, docosanedioic acid, triacontanedioic acid, and combinations thereof;
R₁ is selected from the group consisting of an alkyl group, an aryl group and combinations thereof;
R₂ is selected from the group consisting of an alkyl group, an aryl group and combinations thereof;
R₃ is selected from the group consisting an alkyl group, an aryl group and combinations thereof;
A⁻ is an anion selected from the group consisting of bromide, chloride, iodide, adipate, and succinate, oxalate, malonate, glutarate, pimelicate, subericate (octanedioic carboxylic anion), and combinations thereof;
wherein the alkyl group is CₙH₂ₙ₊₁; and wherein n = 1 to 20.

Disclosed teachings provide a flame retardant intermediate compound represented by the structure of Formula 3:

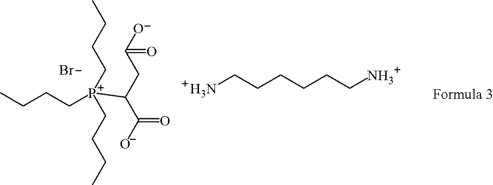 [SMILES: CCCC[P+](CCCC)(CCCC)C(CC(=O)[O-])C(=O)[O-] ; [Br-] ; [NH3+]CCCCCC[NH3+]]

Disclosed teachings provide a flame retardant intermediate compound represented by the structure of Formula 4:

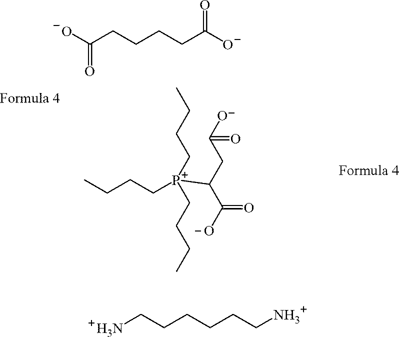

This disclosure provides a method to synthesize halogen-free tributyl phosphonium dicarboxylic acid ionic liquid and incorporate it in a flame-retardant (FR) polyamide monomer.

The disclosure relates to a flame retardant composition containing trialkyl dicarboxylic phosphonium salt.

This disclosure provides a phosphonium salt-containing dicarboxylic acid group as a flame retardant additive to polyamide.

This disclosure provides a phosphonium salt-containing dicarboxylic acid group as a flame retardant additive to polyester.

This disclosure provides a phosphonium salt-containing dicarboxylic acid group as a flame retardant additive to polyimide.

This disclosure provides a flame retardant polymer prepared by reacting to the phosphonium salt-containing dicarboxylic acid group.

This disclosure provides a flame retardant polyamide polymer prepared by reacting to the phosphonium salt-containing dicarboxylic acid group.

This disclosure relates to a trialkyl phosphonium salt-containing dicarboxylic acid group.

This disclosure relates to a flame retardant tri alkyl phosphonium salt-containing dicarboxylate group.

This disclosure provides a flame retardant polymer prepared by reacting the trialkyl phosphonium salt-containing, dicarboxylic acid group.

This disclosure provides a flame retardant polyamide polymer prepared by reacting the trialkyl phosphonium salt-containing, dicarboxylic acid group.

This disclosure relates to a tributyl phosphonium salt-containing dicarboxylic acid group.

This disclosure relates to a flame retardant tributyl phosphonium salt-containing dicarboxylate group.

This disclosure provides a flame retardant polymer prepared by reacting the tributyl phosphonium salt-containing dicarboxylic acid group.

This disclosure provides a flame retardant polyamide polymer prepared by reacting the tributyl phosphonium salt-containing dicarboxylic acid group.

This disclosure provides a flame retardant salt of trialkyl phosphonium dicarboxylic acid and diamino compound.

This disclosure provides a flame retardant salt of tributyl phosphonium dicarboxylic acid and diamino compound.

This disclosure provides a flame retardant salt of tributyl succinyl phosphonium bromide and a diamino compound.

This disclosure provides a flame retardant salt of tributyl succinyl phosphonium bromide and a hexamethylene diamine compound.

The disclosed teachings provide a method of preparing a phosphonium salt with the dicarboxylic acid group, flame retardant synthetic polymer composition containing same, and fibers and fabric prepared from the said flame retardant polymer.

The disclosed teachings provide a composition of a phosphonium salt with dicarboxylic acid groups, which is the precursor for flame retardant polyamide.

The disclosure provides a flame retardant polyamide fiber-containing trialkyl phosphonium group.

The disclosure provides a flame retardant polyamide fiber-containing tributyl dicarboxylic phosphonium composition.

The present invention relates to a flame retardancy of a polyamide fabric treated with phosphonium salt-containing dicarboxylic acid groups, which showed a V0 grade for UL-94 fire testing.

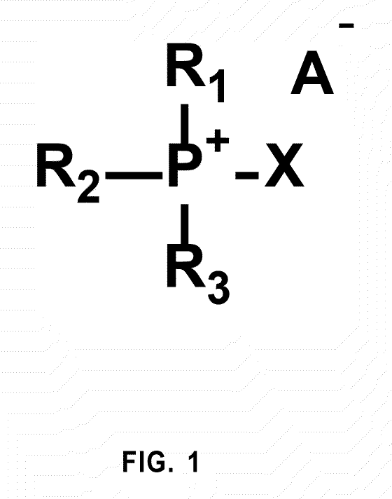

This disclosure provides a composition containing trialkyl phosphonium dicarboxylic cation and a variety of anions. The structure of this invention is provided in FIG. 1, in which X could be any chemical moiety containing dicarboxylic acid group including but not limited to Oxalic acid (ethanedioic acid), Malonic acid (propanedioic acid), Succinic acid (butanedioic acid), Glutaric acid (pentanedioic acid), Adipic acid (hexanedioic acid), Pimelic acid (heptanedioic acid), Suberic acid (octanedioic acid), Azelaic acid (nonanedioic acid), Sebacic acid (decanedioic acid), undecanedioic acid, Dodecanedioic acid, Brassylic acid (tridecanedioic acid), Thapsic acid (hexadecanedioic acid), heneicosanedioic acid, docosanedioic acid, and triacontanedioic acid, R = alkyl (CₙH₂ₙ₊₁, n = 1 to 20) or aryl groups, and A⁻ could be any anion including bromide, chloride, iodide, adipate, and succinate, oxalate, malonate, glutarate, pimelicate, and subericate (octanedioic carboxylic anion).

A phosphorus-containing ionic liquid, a phosphorus-containing a flame retardant additive, and a preparation method thereof are provided. Also provided are co-monomer salt compositions for flame retardant polymers. Also provided are polymers that comprise the phosphorus-containing flame retardant ionic liquid or flame retardant co-monomer salt. The resin composition may be used to make various articles, including fibers, fabrics, and yarns.

### Example 1

Preparation of tributyl succinyl phosphonium bromide is provided in Equation 1.

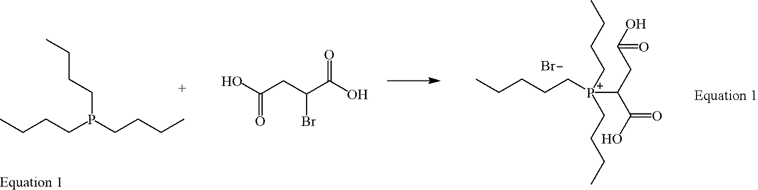

Tributyl succinyl phosphonium bromide was synthesized by reacting bromosuccinic acid and tributyl phosphine in acetonitrile. Initial experiments were conducted by refluxing the reactants at 80° C. A similar reaction was conducted with tributylphosphine and bromosuccunic acid at 20° C. to determine the appropriate reaction condition to yield a pure product. The reaction conducted at room temperature had a pure phase product compared to the reaction conducted at 80° C. After analyzing the product, it was decided to conduct the reaction at room temperature. The high-temperature reaction probably resulted in the dehydration of the dicarboxylic acid. The resulting product was distilled by rotary evaporation to remove the acetonitrile. The final product was an opaque viscous gel at an 80% yield.

### Example 2

The bromide ion in the ‘tributyl succinyl phosphonium bromide’ salt was replaced by ion-exchanging with disodium adipate, as provided in Equation 2.

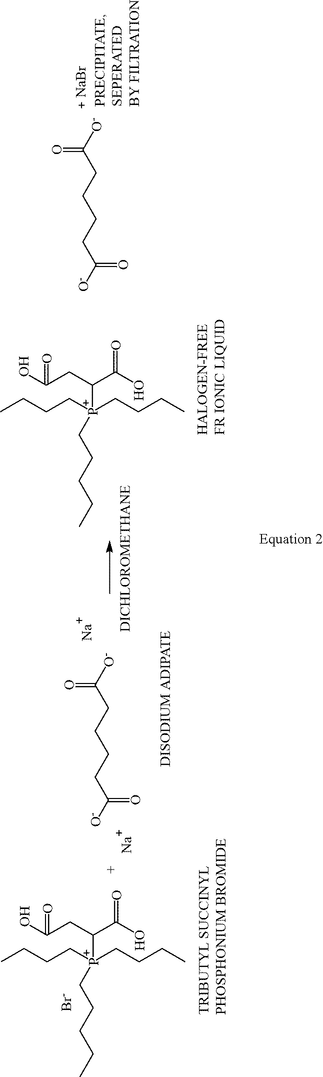

Tributyl succinyl phosphonium bromide ionic liquid and disodium adipate in the 1:0.5 molar ratio were mixed and stirred in dichloromethane for 24 h at room temperature. During the ion-exchange reaction, sodium bromide (NaBr) was precipitated out as described in equation 2. NaBr solid was separated by centrifugation, and the extracted dichloromethane solution was rotoevaporated to produce ‘tributyl succinyl phosphonium adipate’ salt (a new halogen-free ionic liquid). The ion-exchange reaction and formation of tributyl succinyl phosphonium adipate ionic liquid were confirmed by elemental analysis using energy dispersive X-ray analysis (EDX), Attenuated total reflectance spectroscopy (ATR), and nuclear magnetic resonance spectroscopy (NMR).

The phosphonium ionic liquid containing dicarboxylic acids can be reacted with organic amines and diamines to produce salts. Following are illustrative examples of such reactions. Salts containing phosphonium dicarboxylate anions and diammonium anions can be used as co-monomers or as an intermediate compound in the polymer synthesis to provide flame retardant properties to the polymers.

### Example 3

Preparation of Tributyl succinyl phosphonium bromide -1,6 hexamethyl diammonium Salt, referred as “T-H Salt” (also referred to as Formula 3) in this disclosure, is provided in Equation 3.

Tributyl succinyl phosphonium bromide was converted into diamine salt by reacting with 1,6 Hexamethylenediamine (HMDA). Tributyl succinyl phosphonium bromide was dissolved in ethanol. 1,6 hexamethylene diamine [HMDA] was dissolved in distilled water in a separate container to prepare a 70% solution. 70% HMDA solution was added to Tributyl succinyl phosphonium bromide solution dropwise. During the addition, a white precipitate was formed. The solid formed was filtered and washed with ethanol and labelled as T-H salt.

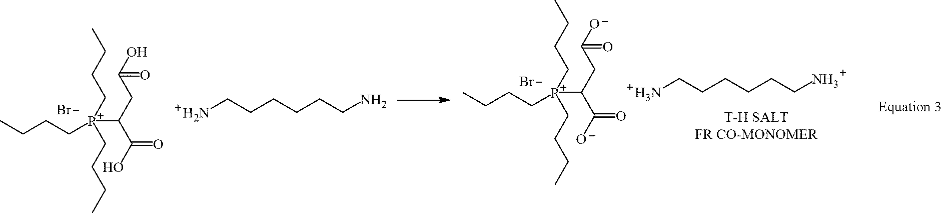

In a similar reaction, Tributyl succinyl phosphonium adipate ionic liquid (Ion-exchanged halogen-free ionic liquid) was reacted with HMDA. The resulting salt was referred as “TAH” salt (also referred to as Formula 4) in this disclosure. The synthesis of Tributyl succinyl phosphonium adipate -1,6 hexamethyl diammonium Salt, (TAH salt) is provided schematically in Equation 4.

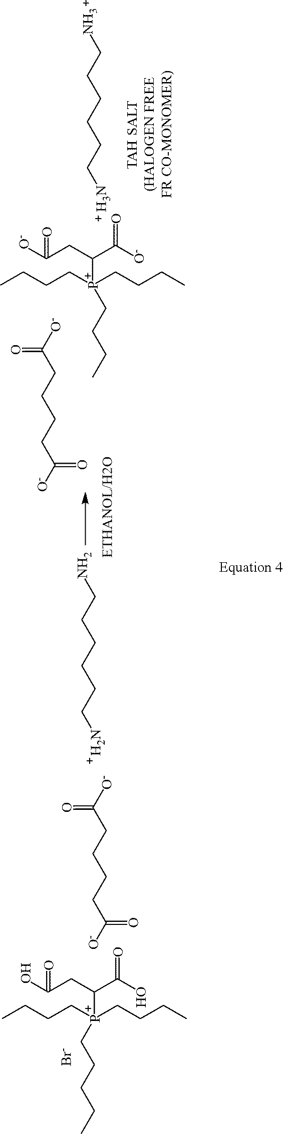

### Structure Analysis

The structure of T-H and TAH samples was analyzed using a variety of techniques, including Attenuated total reflectance spectra (ATR), powder X-ray diffraction (XRD), and proton and P-31 nuclear magnetic resonance (NMR) spectroscopy and energy dispersive X-ray analysis (EDX).

### Attenuated Total Reflectance Spectroscopy (ATR)

Fourier-transform infrared analysis (FTIR) spectra were recorded in the attenuated total reflection (ATR) mode on a Nexus 670 FTIR spectrometer fitted with a silicon detector ATR module. The data were recorded between 600-4000 cm⁻¹ at 4-cm⁻¹ resolution for 72 scans.

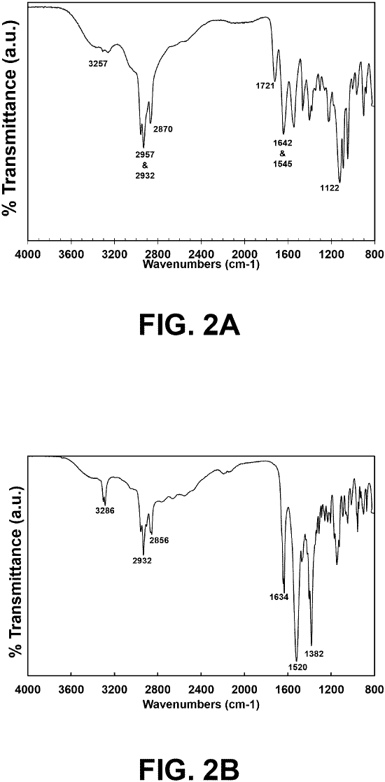

Ion-exchange of adipate anions for bromide ions in T-H salt was confirmed by ATR spectra provided in FIG. 2. Both T-H salt (bromide anion) and TAH salt (adipate anion) showed similar absorbance 3250-3300 cm⁻¹region, attributable to the ammonium group. In both salts, the carbonyl absorbance bands for both monomers were at the 1640-1630 cm⁻¹ region. The peak at 1550-1520 cm⁻¹ is due to N-H deformation and C-N stretching (Amide II). All these peaks are red-shifted to lower wavenumbers in the adipate ion-exchanged TAH salt, indicating the ion-exchange reaction has occurred to replace bromide ions without disrupting the phosphonium anionic structure.

### Nuclear Magnetic Resonance Spectroscopy

¹H and ³¹P nuclear magnetic resonance (NMR) spectra were recorded on a Bruker 400 MHz NMR spectrometer using dimethylsulfoxide-d6 (DMSO-d6) as solvent. Chemical shifts are referred to as tetramethylsilane (TMS) for ¹H and phosphoric acid (H₃PO₄) for ³¹P.

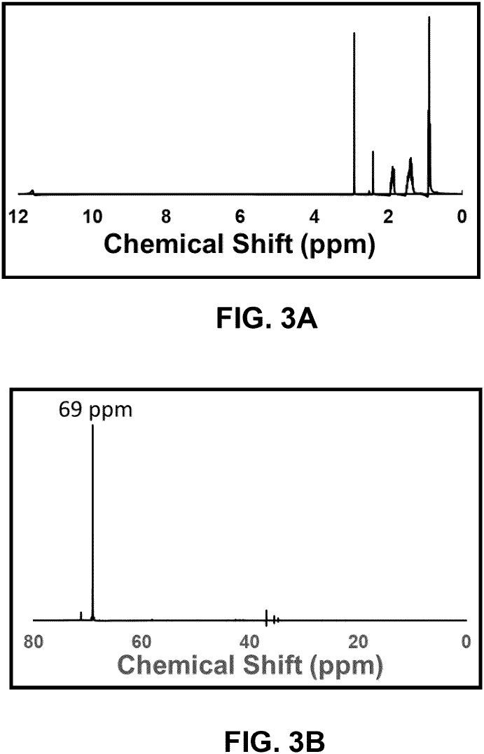

The synthesis of tributyl succinyl phosphonium bromide is confirmed by proton NMR spectra provided in FIG. 3A. The peaks are assigned as follows: 0.90 ppm (9 H, -CH3), 1.45 ppm (12 H, CH2-CH₂), 1.90 ppm (6H, P-CH₂), 2.42 ppm (1H, CH), 2.93 ppm (2H, (C═O)—CH₂, 11.9 ppm (2H, —OH). Liquid ³¹P-NMR spectra of the as-prepared tributyl succinyl phosphonium bromide showed a peak at 69.0 ppm (FIG. 3B) corresponding to Phosphorus in +3 oxidation state, typically of a phosphonium ionic liquid.

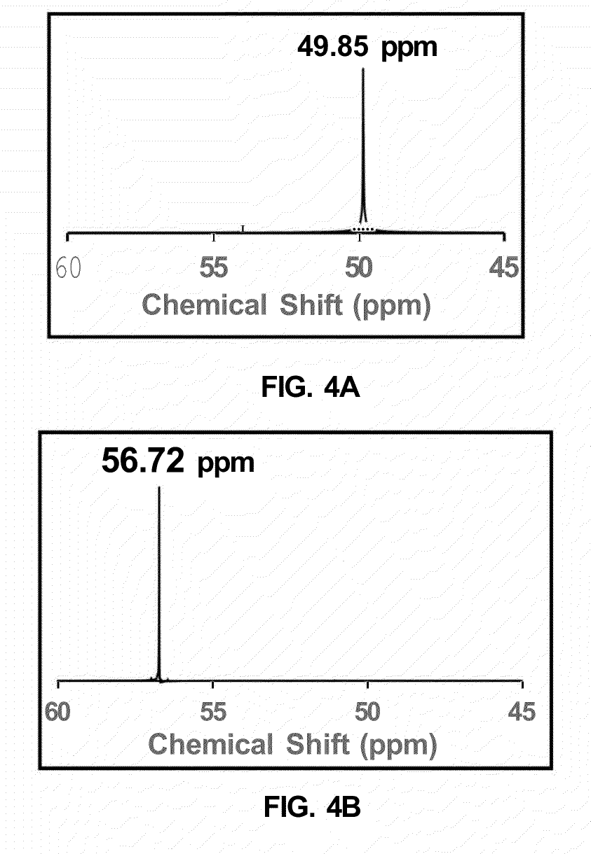

In FIG. 4A, ³¹P liquid NMR spectrum of T-H salt is provided. In FIG. 4B, ³¹P liquid NMR spectrum of TAH salt is provided. NMR resonance peak appears at 49.85 for the T-H (bromide ion-containing salt) (FIG. 4A). This peak was downshifted to 56.72 ppm in the adipate anion containing TAH salt (FIG. 4B). This ³¹P NMR data further confirmed the successful ion-exchange reaction. The ³¹P NMR data did not show any additional resonance peaks corresponding to unreacted T-H salt, indicating the bromide ions are completely replaced with adipate salt after the ion-exchange reaction.

### Example 4

A coating solution containing 30% of Tributyl succinyl phosphonium bromide and 5% Urea in water was prepared. The solution was coated onto 50/50 Nylon/Cotton fabric and cured at 110° C. for 1 hr. The coated fabrics were tested for flame retardancy. After 12-second flame exposure, the coated fabric lost less than 4.6% weight. The char length observed was less than 6 inches, and after flame was less than two seconds. The data clearly indicate the flame retardance property of the tributyl succinyl phosphonium bromide coating.

T-H salt and TAH salts could be used as flame retardant co-monomers or as flame retardant additives or as intermediate compounds in the synthesis of polymers.

Flame-retardant chemicals of this invention, including tributyl succinyl phosphonium bromide, tributyl succinyl phosphonium adipate, and their corresponding salts with 1,6 hexamethylene diamine, namely Tributyl succinyl phosphonium bromide -1,6 hexamethyl diammonium Salt (T-H salt, also referred as Formula 3), and Tributyl succinyl phosphonium adipate-1,6 hexamethyl diammonium Salt (TAH salt, also referred as Formula 4), can be added to polymers prior to the extrusion in the spinning dope or to the spinning bath. These flame retardant chemicals can also be melt spun into fibers or yarns with polymers, including but limited to polyamide 6, polyamide 6,6, polyester, and polyimide.

Flame-retardant chemicals of this invention, including tributyl succinyl phosphonium bromide, tributyl succinyl phosphonium adipate, and their corresponding salts with 1,6 hexamethylene diamine, namely Tributyl succinyl phosphonium bromide -1,6 hexamethyl diammonium Salt (T-H salt), and Tributyl succinyl phosphonium adipate-1,6 hexamethyl diammonium Salt (TAH salt), can be coated onto textile fabrics to impart flame retardant properties to the fabrics.

Following are the structural and properties of the flame retardant polyamide compositions prepared by using conventional high pressure polyamide 6,6 synthesis method. Tributyl succinyl phosphonium bromide -1,6 hexamethyl diammonium Salt (T-H salt), and Tributyl succinyl phosphonium adipate-1,6 hexamethyl diammonium Salt (TAH salt) were used co-monomers along with traditional Polyamide 6,6 co-monomer 1,6-hexamethylene diammonium adipate in the high pressure polyamide synthesis.

T-H salt or intermediate compound or Formula 3 was mixed with traditional Polyamide co-monomer 1,6-hexamethylene diammonium adipate in the FR-polyamide 6,6 synthesis. T-H Salt, 1,6-hexamethylene diammonium adipate, and distilled water were loaded into a high-pressure autoclave reactor. The ratio between T-H salt and 1,6-hexamethylene diammonium adipate was varied from 0 to 50%. The polymerized samples were labeled as ‘FR-PA’. The reactor vessel lid was secured by locking socket head bolts into place. The reactor was then purged with argon. The chamber was then sealed completely and heated to 225° C. This was followed by slow depressurization to ambient pressure (1 atm). Then the reactor was heated upto 290° C. The chamber was then cooled down and opened. The FR-PA sample was separated as a bulk chunk polymer. The flame retardant polyamide polymer prepared by incorporating tributyl succinyl phosphonium bromide-1,6 hexamethyl diammonium Salt (T-H salt), labeled as “FR-PA.”

The flame retardant polyamide polymer prepared by incorporating tributyl succinyl phosphonium adipate-1,6 hexamethyl diammonium Salt (TAH salt) is labeled as “HF-FR-PA″ for halogen-free flame-retardant polyamide.

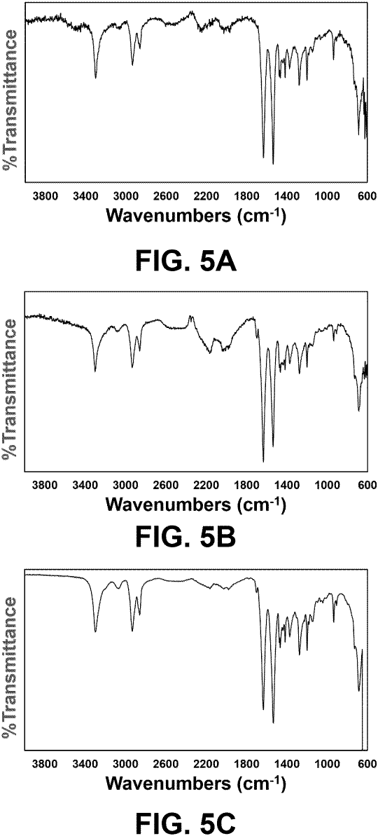

The FT-IR-spectra of all synthesized FR-PA6.6 (FR-PA and HF-FR-PA) were provided in FIGS. 5A, 5B and 5C. The FTIR absorption peaks were similar to the data of reference-Polyamide 6,6. The characteristic absorption bands for aliphatic polyamides were observed at 3300 and 1630 cm⁻¹ (amide I), those for the -CH₂-groups at 2933 and 2859 cm⁻¹, a sharp band at 1275 cm⁻¹ is attributed to a combination of the C—N valence oscillation and the NH-deformation oscillation (Amide III). P—CH₂ stretching vibrations should appear near 1160 cm⁻¹ in accordance with the literature. However, it is difficult to assign a peak in this region because of several overlapping weak peaks due to polyamide groups. In order to verify the incorporation of the phosphorus-containing flame retardants, additional 31P-NMR spectra and elemental analysis (EDX) were recorded to support the findings of the ATR spectroscopy.

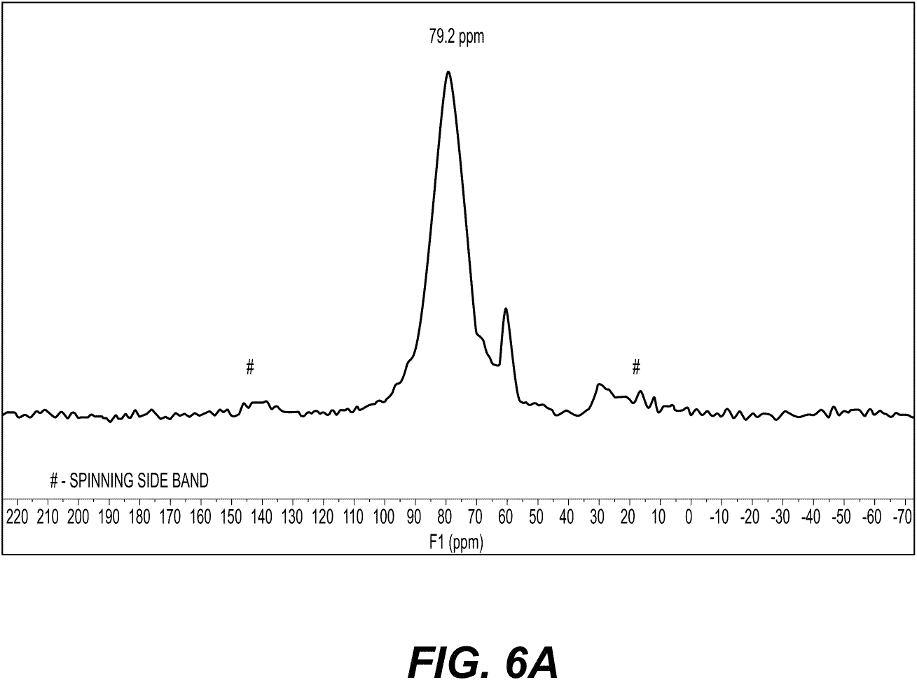

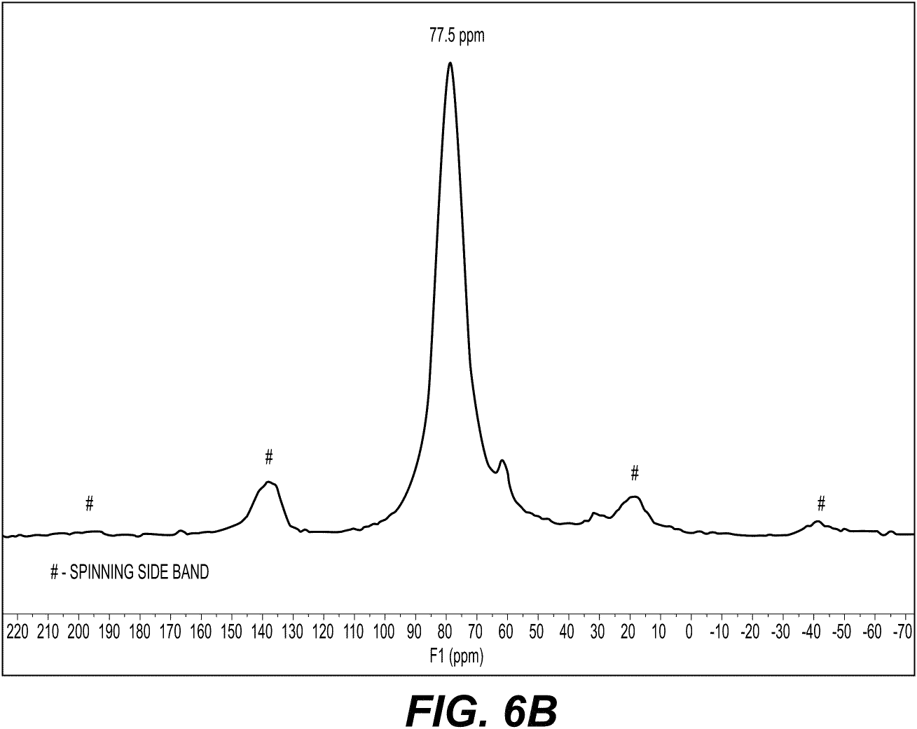

In FIGS. 6A and 6B provide solid-state ³¹P NMR spectra of polyamide polymers FR-PA and HF-FR-PA formed incorporating Tributyl succinyl phosphonium bromide -1,6 hexamethyl diammonium Salt (T-H salt), and Tributyl succinyl phosphonium adipate-1,6 hexamethyl diammonium Salt (TAH salt) respectively, are provided. NMR resonance peak appears at 79.2 ppm for the Tributyl succinyl phosphonium bromide -1,6 hexamethyl diammonium Salt (T-H salt) polymerized polyamide sample. This peak was shifted to 77.4 ppm in the polyamide derived from Tributyl succinyl phosphonium adipate. -1,6 hexamethyl diammonium Salt (TAH salt) The NMR data combined with FTIR data clearly demonstrated the incorporation of phosphorus in the polyamide structure.

### X-Ray Diffraction Analysis

Powder X-ray diffraction patterns (XRD) of the polyamide and flame-retardant polyamide samples were recorded on a Rigaku Miniflex diffractometer using monochromatic Co Kα radiation and a scanning rate of 2 deg min⁻¹. Measurements were conducted in a 2θ range of 10° to 60°.

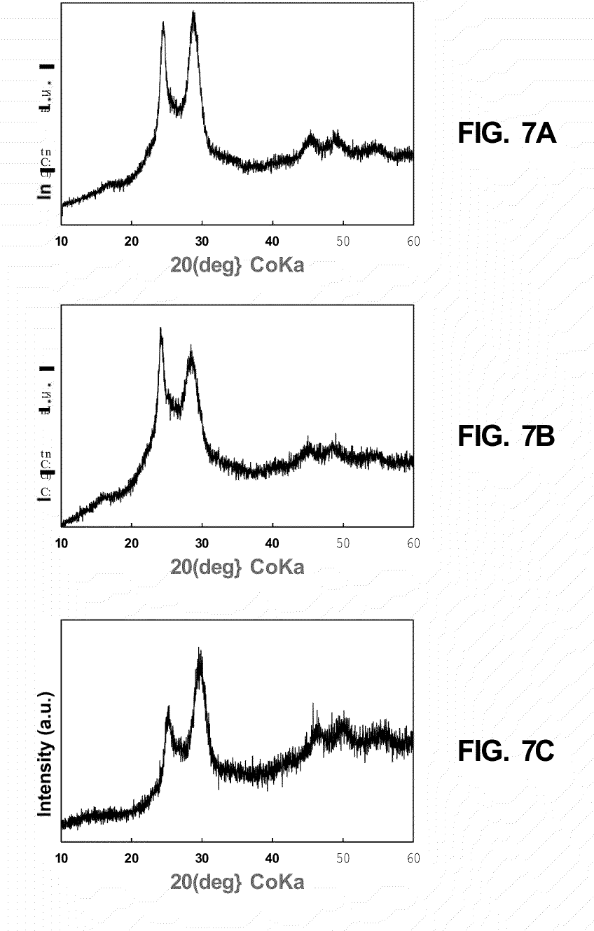

In FIGS. 7A, 7B and 7C, representative XRD patterns of polyamide samples, Polyamide 6,6 Reference (FIG. 7A), FR-PA (FIG. 7B), and HF-FR-PA (FIG. 7C), are provided for comparison. The XRD patterns showed a similar diffraction pattern of a predominantly amorphous phase with crystalline alpha-Phase. The peaks at around 24.5 deg and 28.9 deg correspond to the reflection of (100) and (010, 110) doublet of the alpha Phase of polyamide 6,6 crystals oriented in a triclinic cell. In all these three polymers, the gamma phase (diffraction peak corresponding to gamma phase typically appears in between 24.5 deg and 28.9 deg peaks) was not observed. The XRD patterns clearly demonstrate that introduction of phosphonium groups did not affect the crystallinity of the polyamide phases. This was further confirmed by the reversible melting/recrystallization in the differential scanning calorimetric data.

### Thermogravimetric Analysis (TGA)

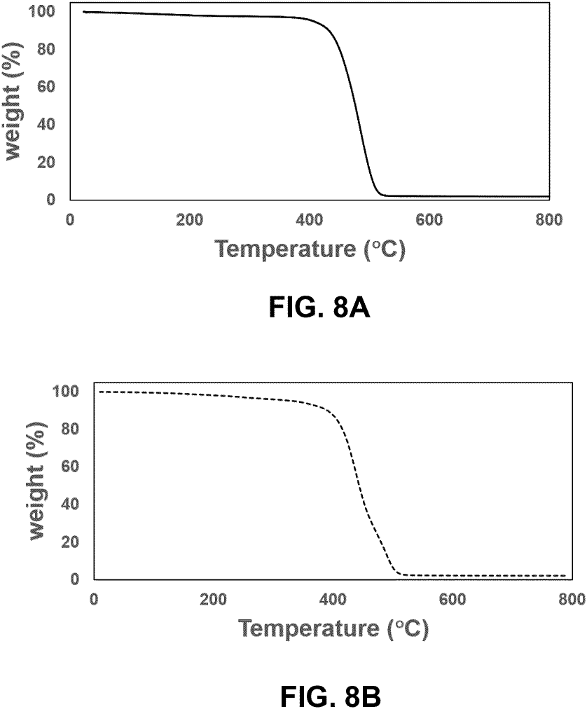

TGA plot of neat polyamide 6,6 polymer in nitrogen is provided in FIG. 8A. The neat Polyamide 6,6 started to decompose at around 428° C. TGA plot of HF-FR-PA in nitrogen is provided in FIG. 8B. The thermal decomposition data of polyamide 6,6 and flame retardant polyamide 6,6 are provided in Table 1. Samples FR-PA and HF-FR-PA started to decompose at 378° C. and 396° C. respectively. All three samples, PA6,6, FR-PA and HF-FR-PA show minimal char residue at 800° C. The mass-loss rate curve at the bottom shows that both neat Polyamide 6,6 exhibit a one-step decomposition, whereas FR-PA and HF-FR-PA have two decomposition peaks which could be attributed to the tributyl phosphonium group loss in the first step. It is interesting to note that ion exchange with adipate anions for bromide ions has improved the thermal stability of the FR-PA.

TABLE 1

Summary of decomposition temperatures

| Sample | Tdec at 10 wt% mass loss (°C) | Tdec at 50 wt% mass loss (°C) | Residue at 800° C. (wt%) |
|---|---|---|---|
| Neat Polyamide 6,6 Reference | 428 | 460 | 4.56 |
| FR-PA | 378 | 422 | 4.53 |
| HF-FR-PA | 396 | 449 | 2.19 |

### Differential Scanning Calorimetry (DSC)

Table 2 summarizes the peak melting and crystallization temperatures denoted as Tₘ₁, T_{c1}, and T_{m2,} respectively. Neat PA6,6 and FR-PA have similar sharp and distinct melting and cooling peaks, which is an indicator of their semicrystalline nature. Both FR-PA and HF-FR-PA have reduced melting temperatures and less distinct melting and crystallization peaks. This could be caused by either lower crystallinity or the existence of phosphonium groups interrupting the polyamide backbone. It is noted that the recrystallization peak of FR-PA is below 150° C. Interestingly, when bromide ions are exchanged with adipate anions, the melting point of the polymer increases by 40° C. (Compare data for FR-PA and HF-FA-PA). The recrystallization temperature is also on par with Polyamide 6,6 reference polymer.

Table 2

Summary of melt and recrystallization peak temperatures

| Sample | Tₘ₁ (°C) | T_{c1} (°C) | Tₘ₁ (°C) |
|---|---|---|---|
| Commercial PA66 | 262 | 228 | 259 |
| FR-PA | 205 | 138 | 191 |
| HF-FR-PA | 246 | 211 | 248 |

### Micro Combustion Calorimetry (MCC)

Micro Combustion Calorimetry results are summarized in Table 3 shows the representative MCC heat release curves. Both FR-PA and HF-FR-PA show two heat release peaks, one slightly above 400° C. and the other one at around 475° C., which is in the same range as neat PA66 and FR-PA. These observations are in agreement with TGA results. It is also noted that the overall total heat release of FR-PA and HF-FR-PA are relatively reduced (56.7% and 20.1%, respectively) compared to FR-PA. Overall, sample FR-PA exhibited the lowest heat release properties.

TABLE 3

Summary of MCC results

| Sample | Heat Release Capacity (J/g-K) | Peak HRR (W/g) | Total HR (kJ/g) | Peak HR temperature (°C) |
|---|---|---|---|---|
| Commercial PA66 | 823.3±4.6 | 821.6±4.8 | 39.6±1.7 | 487.6±6.4 |
| FR-PA | 400.0±6.2 | 399.1±6.2 | 38.7±0.4 | 480.8±2.2 |
| HF-FR-PA | 652.0±53.4 | 605.0±72.0 | 37.9±3.5 | 472.7±2.5 |

### Limiting Oxygen Index

The limiting oxygen index (LOI) was measured using 100 mm × 8 mm× 3 mm rectangle rods to the standard oxygen index test ASTM D2863. Eighteen to 20 test specimens were used for the determination of the LOI. Tests were conducted twice for each flame-retardant polyamide (FR-PA) sample. The LOI value increased from 22.1% for PA66 rectangle stick samples to >34 % for FR-PA samples. These results demonstrated the flame retardancy of FR-PA. The results were further verified on the knitted fabric with the vertical flame testing using the UL-94 standard.

### Monofilament Melt Spinning

Twin-screw extrusion was used for compounding and fiber spinning of the FR-PA samples. A Process 11 co-rotating twin-screw extruder by Thermo-Scientific Inc was used. The extrusion temperature was set at 240° C. The die diameter for fiber spinning was 0.5 mm. The materials were extruded twice to ensure a homogenous blending. First, the formulations containing a mixture of the provided flame retardant materials and neat polyamide 6 were compounded, and the extruded materials were pelletized after the compounded pellets were dried at 80° C. overnight, they were fed into the extruder for the actual fiber spinning.

10 wt% to 25 wt% FR-PA in polyamide 6 provided high-quality compounded materials with consistent and uniform fibers. No breakage occurred during the entire spinning process with a lower FR-PA amount. The collector rotation speed was 20 rpm, and the linear speed was 9.3 mm/s.

### Melt Spinning of Multifilament Yarns

With the successful demonstration of monofilament extrusion, the production of multifilament yarn was attempted using the melt spinning process. The raw polymer product of FR-PA was compounded with polyamide 6 and converted into pellets. After several iterations, the size of the polymer was reduced to a small enough size to be properly fed into the compounding line for repalletizing. The compounded pellets were subjected to a melt spinning process.

Initial melt spinning setup run was conducted with 100% PA6. The initial melt spinning parameters were kept at 210 Denier, 48 filaments, and target 65% Elongation. Once the setup run was successfully completed, the compounded FR-PA pellets were melt-spun into multifilament yarns. The mechanical properties of the pristine polyamide 6 and FR-PA-10/PA6 are provided in Table 4.

TABLE 4

echanical properties of melt-spun yarns

| Property | Polyamide 6 | FR-PA/Polyamide 6 |
|---|---|---|
| Denier (gram per 9000 meters) | 217 | 267 |
| Shrinkage, % | 6.4 | 5.19 |
| Entanglement, tpm | 31 | 28 |
| Elongation, % | 66.2 | 78.3 |
| Tenacity, gpd | 4.11 | 3.30 |
| Finish on Yarn: % | 3.04 | 2.66 |

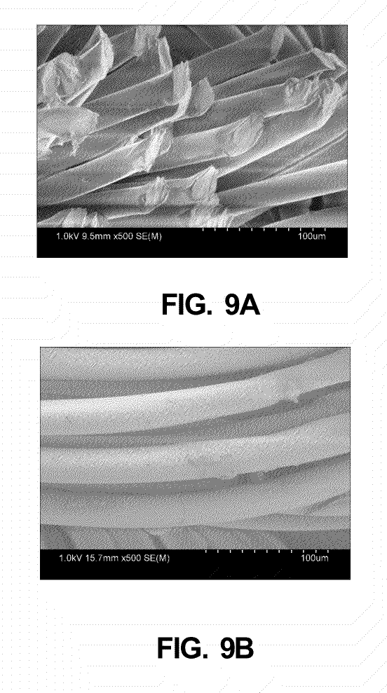

Scanning electron microscopic (SEM) images of the filaments of both pristine polyamide 6 and flame-retardant polyamide are provided in FIGS. 9A and 9B. The fibers are about 20 microns in thickness. The images show smooth, defect-free surfaces without any deformation or fractures. In summary, the data outlined in Table 4 show that the blending of FR-PA samples with PA6 does not significantly affect the mechanical properties of the resulting PA materials and the flame-retardant multifilament yarns behave similarly to PA6 with good mechanical strength.

### Preparation of Knitted Fabrics

Knitted fabrics were produced on a single-cylinder circular knitting machine with smooth yarns. The knitted fabric was folded from 48 multifilament fibers (267 deniers). The fabric weights were PA6-reference, 226 gm⁻²; FR-PA/PA6, 260 gm⁻². Similar to PA6-Reference fabric, FR-fabric was also highly stretchable.

### Vertical Burning Tests of Knitted Fabrics

Test samples for the vertical burning test were taken from the knitted fabric. Burning time was recorded by means of a stopwatch. The ignition of the cotton placed below by burning melt drops, burning time, and the achieved burning distance by the fire were the parameters used to evaluate the fire classification. To determine reproducibility, burning tests were repeated five times for each FR-PA sample. The vertical flame testing (UL-94) data are compared in Table 5 for pristine polyamide 6 fabric and FR-PA fabric. Both these fabrics are knitted with similar parameters in the same knitting machine to provide a one-on-one comparison of properties.

TABLE 5

UL-94 Fire testing of knitted fabrics

| | | |
|---|---|---|
| UL-94 Parameter | PA6 Fabric | FR-PA6 Fabric |
| Flame Time | 12 s | 12 s |
| Flame extinction | > 90 s | 2-10 s |
| Forms melting drips | Yes | Yes |
| Cotton wool ignite | Yes | No |
| Melting Distance | 5.5 inch | 1.9 inch |
| Rating Grade according to UL-94 | V-2 | V-0 |

Other modifications and variations to the invention will be apparent to those skilled in the art from the foregoing disclosure and teachings. Thus, while only certain embodiments of the invention have been specifically described herein, it will be apparent that numerous modifications may be made thereto without departing from the spirit and scope of the invention.

What is claimed is:

1. A flame retardant ionic liquid compound represented by the structure of Formula 1: 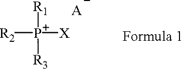
wherein
X is a chemical moiety comprising a dicarboxylic acid group selected from the group consisting of oxalic acid (ethanedioic acid), malonic acid (propanedioic acid), succinic acid (butanedioic acid), glutaric acid (pentanedioic acid), adipic acid (hexanedioic acid), pimelic acid (heptanedioic acid), suberic acid (octanedioic acid), azelaic acid (nonanedioic acid), sebacic acid (decanedioic acid), undecanedioic acid, dodecanedioic acid, brassylic acid (tridecanedioic acid), thapsic acid (hexadecanedioic acid), heneicosanedioic acid, docosanedioic acid, triacontanedioic acid, and combinations thereof;
R₁ is selected from the group consisting of an alkyl group, an aryl group and combinations thereof;
R₂ is selected from the group consisting of an alkyl group, an aryl group and combinations thereof;
R₃ is selected from the group consisting an alkyl group, an aryl group and combinations thereof;
A- is an anion selected from the group consisting of bromide, chloride, iodide, adipate, and succinate, oxalate, malonate, glutarate, pimelicate, subericate (octanedioic carboxylic anion), and combinations thereof;
wherein the alkyl group is CₙH₂ₙ₊₁; and wherein n = 1 to 20.

2. A flame retardant intermediate compound represented by structure of Formula 2: 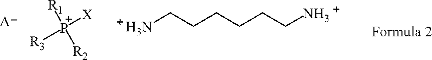
wherein
X is a chemical moiety comprising a dicarboxylic acid group selected from the group consisting of oxalic acid (ethanedioic acid), malonic acid (propanedioic acid), succinic acid (butanedioic acid), glutaric acid (pentanedioic acid), adipic acid (hexanedioic acid), pimelic acid (heptanedioic acid), suberic acid (octanedioic acid), azelaic acid (nonanedioic acid), sebacic acid (decanedioic acid), undecanedioic acid, dodecanedioic acid, brassylic acid (tridecanedioic acid), thapsic acid (hexadecanedioic acid), heneicosanedioic acid, docosanedioic acid, triacontanedioic acid, and combinations thereof;
R₁ is selected from the group consisting of an alkyl group, an aryl group and combinations thereof;
R₂ is selected from the group consisting of an alkyl group, an aryl group and combinations thereof;
R₃ is selected from the group consisting an alkyl group, an aryl group and combinations thereof;
A- is an anion selected from the group consisting of bromide, chloride, iodide, adipate, and succinate, oxalate, malonate, glutarate, pimelicate, subericate (octanedioic carboxylic anion), and combinations thereof;
wherein the alkyl group is CₙH₂ₙ₊₁; and wherein n = 1 to 20.

3. A flame retardant polymer comprising a polymerization product of the flame retardant ionic liquid compound of claim 1.

4. The flame retardant polymer of claim 3 selected from the group consisting of a polyamide, a polyester, a polyurethane, a polyimide and combinations thereof.

5. A flame retardant polyamide comprising a polymerization product of the flame retardant intermediate compound of claim 2.

6. A flame retardant intermediate compound of claim 2 represented by the structure of Formula 3: 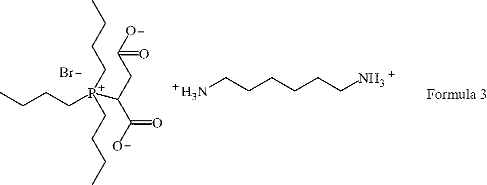 [SMILES: CCCC[P+](CCCC)(CCCC)C(CC(=O)[O-])C(=O)[O-] ; [Br-] ; [NH3+]CCCCCC[NH3+]]
.

7. A flame retardant intermediate compound of claim 2 represented by the structure of Formula 4: 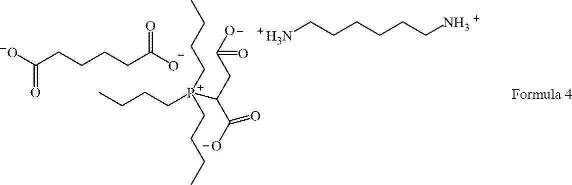 [SMILES: O=C([O-])CCCCC(=O)[O-] ; CCCC[P+](CCCC)(CCCC)C(CC(=O)[O-])C(=O)[O-] ; [NH3+]CCCCCC[NH3+]]
.
